(19) United States
(12) Patent Application Publication
(10) Pub. No.: US 2020/0032002 A1
(43) Pub. Date: Jan. 30, 2020

(54) METHOD FOR GRAFTING POLYPHENOLS

(71) Applicant: Arkema France, Colombes (FR)

(72) Inventors: Jean-Philippe Gillet, Brignais (FR); Béatrice Allard-Breton, Irigny (FR); Rémy Teissier, Lyon (FR); Jérôme Blanc, Brignais (FR)

(73) Assignee: Arkema France, Colombes (FR)

(21) Appl. No.: 16/603,381

(22) PCT Filed: Apr. 13, 2018
(86) PCT No.: PCT/FR2018/050934

§ 371 Date: Oct. 7, 2019

(30) Foreign Application Priority Data
Apr. 13, 2017 (FR) 1753258

(51) Int. Cl. C08H 7/00; C08G 18/48; C08G 18/64

(52) U.S. Cl. CPC C08H 6/00; C08G 18/6492; C08G 18/4879

(57) ABSTRACT

The invention relates to a process for producing at least one grafted polyphenol, comprising at least the step of reacting, in the presence of at least one catalyst, at least one polyphenol with at least one compound of formula (I) below:

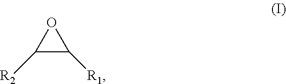

wherein:
R₁ is a linear or branched, saturated or unsaturated, C₃-C₃₀, preferably C₃-C₂₀, more preferentially C₈-C₂₀, even more preferentially C₈-C₁₈, hydrocarbon-based chain, optionally comprising one or more saturated or unsaturated rings, said chain being optionally interrupted by one or more heteroatoms chosen from O, S and N, preferably chosen from O and S, more preferably O;
R₂ is chosen from a hydrogen atom and a linear or branched, saturated or unsaturated, C₁-C₆₀ hydrocarbon-based chain, optionally comprising one or more saturated or unsaturated rings, said chain being optionally interrupted by one or more heteroatoms chosen from O, S and N, preferably chosen from O and S, more preferably O, the number of moles of said compound of formula (I) being greater than or equal to the number of —OH functions present per mole of said polyphenol.

The invention relates to a process for producing grafted and alkoxylated polyphenols, more specifically lignins, which undergo grafting and alkoxylation reactions.

Lignin constitutes one of the principal components of wood, with cellulose and hemicellulose. Lignin is the most abundant biopolymer on Earth, after cellulose. It gives wood rigidity by interpenetrating the cellulose network while at the same time conferring resistance to water and to certain wood parasites.

Although it is abundant, it must be stated that lignin is exploited very little as such. Up until now and still today, the primary exploitation of lignin is energy recovery, in particular via the burning of black liquors. This exploitation is important for the financial balance of paper pulp factories. However, in the face of the drop in production of paper pulp and in excess amounts of lignins, work is being carried out for a better exploitation of said lignin.

Thus, the interest in the use of lignin has grown in recent years. One field in which the properties of lignin are exploited is the reinforcement of a multitude of polymers, in particular urethane-based polymers. Indeed, lignin can be used for the purpose of producing polyurethane foam derivatives. Since lignin is a polyphenol, it has a large number of alcohol functions that are capable of reacting, for example with isocyanates to form polyurethane derivatives.

However, since these alcohol functions are difficult to access within this polyphenol, one possibility is to carry out, beforehand, a reaction for propoxylation of these functions, resulting in alcohol functions that are less bulky (further away from the nucleus of the polyphenol) and as a result more accessible.

As a general rule, the process used by various authors consists first of all in a propoxylation of the lignin by reacting the lignin with propylene oxide in the presence of a catalyst, and then in reacting the product obtained with, for example, isocyanate.

Regarding the lignin propoxylation step, the authors usually carry the process out in autoclaves or Parr bombs. All of the lignin, for example kraft lignin, is loaded with propylene oxide and a basic catalyst in suitable proportions under a nitrogen atmosphere. The reactor is subsequently closed and then heated.

The reaction is initiated around 150° C. with a strong exothermicity which causes a sudden rise in temperature to 250° C. and at a pressure of a few bar to more than 20 bar (2 MPa). The authors consider that the reaction is complete when the pressure and temperature decrease and reach a stable stationary phase.

Given the strong exothermicity of the reaction, the authors must ensure strict control and mastering of the reaction conditions for safety reasons. The process currently used is therefore not easily industrially transposable.

According to the thesis entitled “Lignin-based Polyurethanes: Characterization, Synthesis and Applications” Borges Cateto, (2008), lignin, propylene oxide and a catalyst are introduced into a reactor which is closed and which is then heated to 160° C. The pressure and temperature increase to a maximum that depends on a certain number of parameters. The propoxylated lignin is recovered at the end of the reaction. It is indicated in this document that the reaction was carried out on 100 g samples.

Moreover, given the temperature and pressure conditions and the residual presence of water, a portion of the propylene oxide may be homopolymerized, as mentioned in EP2816052. The propoxylated lignin is then mixed with poly(propylene) glycols, which cannot be readily separated from the propoxylated lignin.

That being said, some authors have managed to overcome the problem of exothermic control as mentioned above. Indeed, WO2015083092 describes a process in which a solid lignin dispersion is produced in a polyethylene glycol dispersant, di- or tetraethylene glycol or propoxylated glycerol followed by the addition of a base. Then, propylene oxide is added continuously.

Nevertheless, the product produced is a mixture of propoxylated lignin and dispersant, which is possibly propoxylated, and which is difficult to separate from the propoxylated lignin. It should also be noted that the reaction times are extremely long, the temperature during the reaction is low and the pressure during the reaction that is used is low or close to atmospheric pressure.

Similarly, US20150038665 describes a process in which propylene oxide is continuously added to a mixture consisting of lignin, glycerol, lignin polyol and a catalyst. However, this process has the great disadvantage of leaving in the finished product a mixture of propoxylated lignin with glycerol or propoxylated glycerol. Indeed, it is difficult to purify the product obtained.

Moreover, it should be noted that the lignin is in solid form. Because of this, it is difficult to use it in the form of a homogeneous reaction medium. It furthermore tends to generate deposits that can clog various components of a facility, such as for example reactors, pipes, valves, ducts, and the like. For this reason, it is also difficult to handle on an industrial level.

The above references disclose suspending lignin in dispersants. However, these processes require subsequent separation steps to isolate the propoxylated lignin from the by-products of the reaction of the dispersant with the reagents. Furthermore, the reaction conditions employed are not necessarily compatible with industrial use.

In a technical field very different than that of polyurethane synthesis, WO 2008/123888 describes the synthesis of rheology agents for drilling muds. This fluid may comprise a modified lignin-based polymer. However, this product must be ground at the end of the reaction. This solid is then incorporated into a two-phase emulsion.

Thus, a means for rendering polyphenols, such as lignin, liquid in order to facilitate their use on an industrial level is in particular sought.

The present invention aims to propose a solution which makes it possible to solve all of the problems mentioned above.

Thus, the first subject of the present invention is a process for producing at least one grafted polyphenol, comprising at least the following step:

(a) reacting, in the presence of at least one catalyst, at least one polyphenol with at least one compound of formula (I) below:

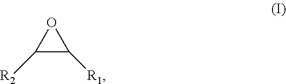

wherein:
R₁ is a linear or branched, saturated or unsaturated, C₃-C₃₀, preferably C₃-C₂₀, more preferentially C₈-C₂₀, even more preferentially C₈-C₁₈, hydrocarbon-based chain, optionally comprising one or more saturated or unsaturated rings, said chain being optionally interrupted by one or more heteroatoms chosen from the oxygen atom (O), the sulfur atom (S) and the nitrogen atom (N), preferably chosen from O and S, more preferably O;
R₂ is chosen from a hydrogen atom and a linear or branched, saturated or unsaturated, C₁-C₆₀ hydrocarbon-based chain, optionally comprising one or more saturated or unsaturated rings, said chain being optionally interrupted by one or more heteroatoms chosen from the oxygen atom (O), the sulfur atom (S) and the nitrogen atom (N), preferably chosen from O and S, more preferably O,
   the number of moles of said compound of formula (I) being greater than or equal to the number of —OH functions present per mole of said polyphenol.

The process according to the invention makes it possible to react a very large majority of the —OH functions, preferably all the —OH functions, present on a polyphenol with the compound of formula (I), so that said process makes it possible to lead to a polyphenol of which the —OH functions, preferably all —OH functions, have reacted with the epoxide function of the compound of formula (I).

Indeed, the Applicant has discovered that by grafting a specific compound of formula (I) onto a polyphenol in a specific amount, said grafted polyphenol goes from the solid state to a homogeneous liquid (or viscous) state, which is therefore easier to handle, in particular when hot.

Moreover, the process according to the invention makes it possible to make a very large majority of the —OH functions, preferably all the —OH functions, present on the polyphenol accessible. Indeed, it proves to be the case that the grafting of the compound of formula (I) onto the hydroxyl functions of the polyphenol leads to the formation of a grafted polyphenol of which the hydroxyl functions are further away from the aromatic ring of the polymer structure, that is to say more accessible and more reactive.

Thus, the grafted polyphenol obtained by the process according to the invention can also be considered to be an extremely valuable reagent for an alkoxylation reaction, which may be referred to as “subsequent”.

In addition, the use of the liquid or viscous grafted polyphenol makes it possible to carry out subsequent alkoxylations in good safety conditions, so that they can be easily implemented on an industrial scale. Indeed, the operating conditions in terms of temperature and pressure are more easily controlled because the medium is in the form of a homogeneous liquid having a viscosity compatible with an industrial process, that is to say a viscosity generally ranging from 0.7 Pa·s to 40 Pa·s. The exothermicity of the reaction can in particular be easily controlled. In addition, the subsequent alkoxylation process makes it possible to obtain an alkoxylated polyphenol with a good yield and in entirely reasonable reaction times that are compatible with industrial use.

Other advantages and features of the invention will become more clearly apparent on examining the detailed description and the appended drawings, wherein:

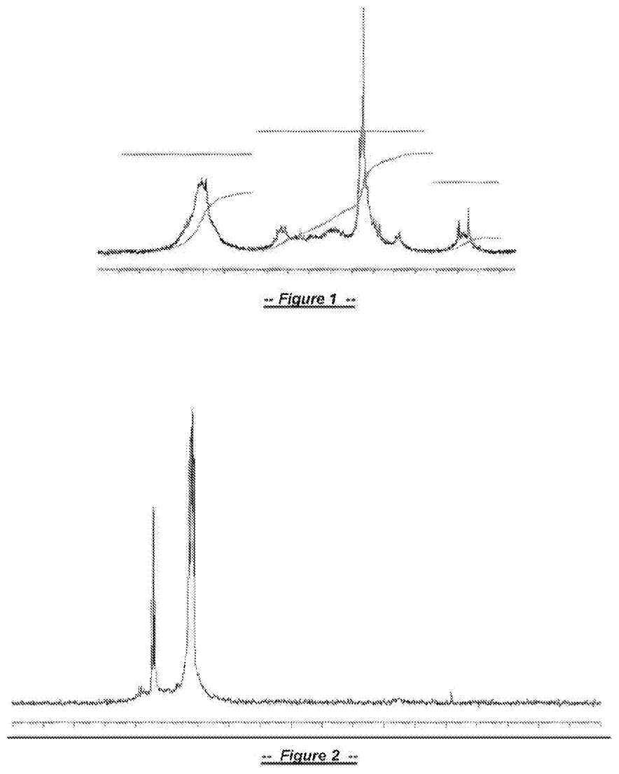

FIG. 1 is a ³¹P NMR spectrum of an initial Kraft lignin derivatized with a phosphorus-comprising reagent;

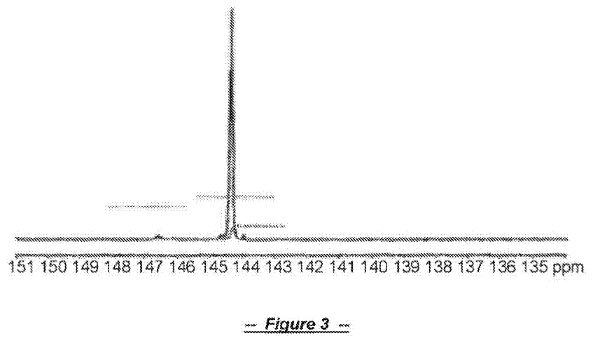

FIG. 2 is a ³¹P NMR spectrum of a grafted polyphenol, derivatized by a phosphorus-comprising reagent, that is to say the initial Kraft lignin after reaction according to step (a), and then derivatized;

FIG. 3 is a ³¹P NMR spectrum of an alkoxylated polyphenol and derivatized by a phosphorus-comprising reagent, that is to say the initial Kraft lignin after reaction according to step (a) and then according to step (b), then derivatized.

For the purposes of the present invention, the term “hydrocarbon-based chain” or “hydrocarbon-based radical” is intended to mean, respectively, a chain or a radical comprising one or more carbon atoms and one or more hydrogen atoms.

It is specified that the expression “from . . . to . . . ” used in the present description should be understood as including each of the limits mentioned.

Throughout the text, the pressures are expressed in absolute megaPascals (MPa).

### Step (a)

The process according to the invention comprises a step (a) reacting, in the presence of at least one catalyst, at least one polyphenol with at least one compound of formula (I) below:

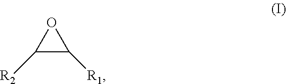

wherein R₁ and R₂ are as defined above,
the number of moles of said compound of formula (I) being greater than or equal to the number of —OH functions present per mole of said polyphenol.

Said number of moles of said compound of formula (I) depends on the number of —OH functions present per mole of said polyphenol. This number of —OH functions present in a mole of said polyphenol is easily determined by those skilled in the art by applying the method described for example in the thesis entitled “Lignin-based Polyurethanes: Characterization, Synthesis and Applications” Borges Cateto, (2008), 57-66, or else in the document “2-Chloro-4,4,5,5-tetramethyl-1,3,2-dioxaphospholane, a Reagent for the Accurate Determination of the Uncondensed and Condensed Phenolic Moieties in Lignins”, Argyropoulos et al., (1995), J. Agr. Food. Chem., 43, 1543-1544.

Preferably, the grafted polyphenol resulting from step (a) has an average molecular weight Mw ranging from 500 to 25 000, preferably from 500 to 20 000, more preferably from 1000 to 20 000, most preferably 1500 to 10 000.

The average molecular weight Mw can be easily determined by those skilled in the art by applying the method described for example in the document “Molar mass determination of lignins by size-exclusion chromatography: towards standardization of the method” Baumberger et al., Holzforschung, 61, 459-468, (2007).

### Polyphenols

The polyphenols used in the process according to the invention may be chosen from tannins, lignins and natural polyphenols other than tannins and lignins, preferably lignins.

Advantageously, said polyphenol is a lignin, preferably chosen from Kraft lignin, lignosulfonates and organosolv lignins.

Kraft lignin results from the papermaking process of the same name. In terms of chemical structure, Kraft lignin is a combination of three phenolic compounds, coumaryl alcohol, coniferyl alcohol and sinapyl alcohol. As an example of Kraft lignin, it is possible to use, inter alia, Indulin AT™ sold by Ingevity, Kraft lignin sold by Fibria, or else the lignin sold by Stora Enso.

Lignosulfonates differ structurally from kraft lignin by the presence of generally salified sulfonic functions, which gives them better solubility in water. Examples of lignosulfonates are lignosulfonates of the Borresperse™, Ultrazine™, Ufoxane™ or else Vanisperse™ type from Borregaard.

Organosolv lignins are obtained by chemical attack of ligneous plants, such as cereal straw, using various solvents, such as formic acid or acetic acid. Among the various sources of organosolv lignins is Biolignin™ sold by CIMV or that sold by Fibria.

Preferably, the polyphenol used is lignin.

### Catalyst

Step (a) of the process according to the invention is carried out in the presence of at least one catalyst.

The catalyst may be chosen from alkali metal hydroxides, sodium or potassium alkoxides, and tertiary amines chosen from trialkylamines and tetramethylguanidine, preferably chosen from alkali metal hydroxides.

More preferentially, the catalyst used in the process according to the invention may be chosen from lithium hydroxide, sodium hydroxide, potassium hydroxide and cesium hydroxide.

Advantageously, the catalyst represents from 0.01 to 10% by weight, preferentially from 1 to 6% by weight relative to the weight of polyphenol.

Preferably, the catalyst is in the form of an aqueous solution.

Nature of the radicals R₁ and R₂

Preferably, R₁ is chosen from:
a group of formula (II) below: —(CH₂)ₙ—CH₃ (II), wherein n is an integer ranging from 2 to 29, preferably from 2 to 19, more preferentially from 7 to 19, even more preferentially from 7 to 17;
a group of formula (III) below:

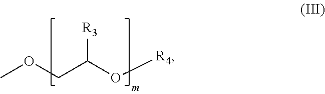

wherein:
R₃ is chosen from a hydrogen atom, a C₁-C₃ alkyl radical and a phenyl group, preferably a C₁-C₃ alkyl radical, more preferably a methyl radical;
m is an integer ranging from 1 to 15, preferably from 2 to 15, more preferentially from 2 to 10, even more preferentially from 2 to 5; and
R₄ denotes a hydrogen atom or a C₁-C₂₀ hydrocarbon-based chain, preferably R₄ denotes a C₁-C₂₀, preferably C₁-C₁₂, more preferentially C₁-C₈, hydrocarbon-based chain, more preferably R₄ denotes a methyl radical;
a group of formula (IV) below:

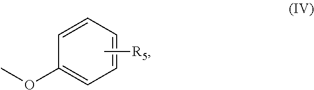

wherein R₅ denotes a linear or branched, saturated or unsaturated, C₅-C₂₀, preferably C₈-C₁₈, more preferentially C₁₅, hydrocarbon-based radical.

When R₁ is a group of formula (II) below: —(CH₂)ₙ—CH₃ (II), the compound of formula (I) may be a product available under the trade name Vikolox® from Arkema for alkanes, or Vikoflex® from Arkema for vegetal oil epoxides.

When R₁ is a group of formula (IV) as mentioned above, wherein R₅ is a C₁₅ radical substituted in the meta position, the compound of formula (I) may be a product available under the trade name Cardolite® NC-513 from Cardolite.

Advantageously, R₂ is chosen from a hydrogen atom and a linear or branched, saturated or unsaturated, C₁-C₄₀ hydrocarbon-based chain, more advantageously from a hydrogen atom and a linear or branched, saturated or unsaturated, C₁-C₂₀ hydrocarbon-based chain, even more advantageously from a hydrogen atom and a linear or branched, saturated or unsaturated, C₁-C₈ hydrocarbon-based chain, and most particularly preferably, R₂ represents a hydrogen atom.

Advantageously, the number of moles of said compound of formula (I) is at least 1.1 times greater than or equal to, preferably at least 1.5 times greater than or equal to, more preferably at least two times greater than or equal to, even more preferentially at least three times greater than, particularly preferably at least four times greater than the number of —OH functions present per mole of said polyphenol.

### Reaction Conditions

Step (a) according to the invention can be carried out at a temperature ranging from 80° C. to 200° C., preferentially from 100° C. to 180° C. The reaction is generally, and preferably, carried out under atmospheric pressure. It is also possible to optionally carry out the reaction at a pressure below atmospheric pressure.

Preferably, the duration of step (a) varies from a few minutes to several hours, preferentially from 5 minutes to 72 hours, more preferentially from 10 minutes to 24 hours, even more preferentially from 10 minutes to 12 hours.

Advantageously, step (a) is carried out without solvent.

According to one embodiment, it is possible to operate using an extruder. The solid (starting lignin) is, in this case, impregnated with an aqueous solution of catalyst, the water is removed, and a compound of formula (I) is then introduced. A grafted polyphenol from step (a) is then obtained.

A subject of the invention is also a process for producing an alkoxylated polyphenol, comprising step (a) as defined above, followed by the following step:
(b) reacting the grafted polyphenol obtained at the end of step (a) with at least one alkoxylating agent of formula (V) below:

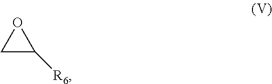

wherein R₆ denotes a hydrogen atom or a C₁-C₂ alkyl radical.

This process makes it possible in particular to make the —OH functions of the grafted polyphenol more accessible. In addition, by virtue of this process, the viscosity of the grafted polyphenol is lower, that is to say that said polyphenol is even more easy to handle, in particular than the polyphenol from step (a).

### Catalyst

Step (b) is preferably carried out in the presence of a catalyst. Said catalyst may be identical to or different than the catalyst used in step a). If the catalyst of step b) is identical to the catalyst of step a), either no additional catalyst is added, or a supplementary amount of catalyst is added.

The catalyst used during step (b) may be chosen from alkali metal hydroxides, sodium or potassium alkoxides, and tertiary amines chosen from trialkylamines and tetramethylguanidine, preferably chosen from alkali metal hydroxides.

More preferentially, said catalyst is chosen from lithium hydroxide, sodium hydroxide, potassium hydroxide and cesium hydroxide.

Advantageously, the catalyst used in step (b) represents from 0.01 to 10% by weight, preferentially from 1 to 6% by weight, relative to the weight of grafted polyphenol from step (a).

### Reaction Conditions

Step (b) according to the invention may be carried out at a temperature ranging from 80° C. to 200° C., preferentially from 100° C. to 180° C. The reaction pressure during step (b) can range from 0.15 MPa to 3 MPa, preferentially from 0.2 MPa to 2 MPa.

Preferably, the duration of step (b) varies from a few minutes to several hours, preferentially from 5 minutes to 24 hours, more preferentially from 10 minutes to 12 hours, even more preferentially from 10 minutes to 10 hours.

According to a particular embodiment of the invention, said alkoxylating agent of formula (V) is chosen from ethylene oxide, propylene oxide, butylene oxide, and mixtures thereof. Preferably, the grafted polyphenol/alkoxylating agent weight ratio is from 0.05 to 2, preferentially from 0.1 to 1.5.

At the end of step b), a compound is recovered which is an alkoxylate of the grafted polyphenol.

Advantageously, a step of removing the residual alkoxylating agent of formula (V) is is carried out.

For the purposes of the present invention, the term “residual alkoxylating agent” means an alkoxylating agent which has not reacted.

Preferably, said step of removing the residual alkoxylating agent of formula (V) is carried out by cooking, that is to say by maintaining a temperature ranging from 70° C. to 200° C., preferentially from 100° C. to 180° C., in order to consume the residual alkoxylating agent of formula (V), and/or by means of a stripping step under an inert gas stream. Alternatively, said stripping step may be carried out under steam or under a vacuum.

Preferably, after the step of removing the residual alkoxylating agent, the weight content of said residual alkoxylating agent of formula (V) is less than or equal to 1% relative to the weight of alkoxylated polyphenol obtained at the end of step (b), preferentially less than or equal to 0.1%, more preferentially less than or equal to 0.01%.

The grafted polyphenol and the grafted polyphenol alkoxylate (subsequently also referred to as alkoxylated polyphenol) obtained are in the form of more or less viscous liquids.

Moreover, the process for producing a grafted polyphenol or an alkoxylated polyphenol according to the invention can be carried out batchwise or semi-continuously.

The initial lignin is impregnated with an aqueous solution of catalyst. The lignin is dried and added to a compound of formula (I) in a stirred reactor so as to obtain a grafted polyphenol from step (a). Then, an agent of formula (V) is added, and reacts with the grafted polyphenol from step (a).

At the end of the reaction, the alkoxylated polyphenol obtained at the end of step (b) is directly recovered from the reactor, the reaction medium preferably containing no solvent.

The crude product from step (a) or the crude product from step (b) can be used directly as it is, without the need for subsequent separation or purification.

### Products Obtained By The Process

A subject of the invention is also a grafted polyphenol that can be obtained by the process for producing a grafted polyphenol according to the invention, and also an alkoxylated polyphenol that can be obtained by the process for producing an alkoxylated polyphenol according to the invention.

A subject of the invention is also a grafted polyphenol directly obtained by the process for producing a grafted polyphenol according to the invention, and also an alkoxylated polyphenol directly obtained by the process for producing an alkoxylated polyphenol according to the invention.

### Alkoxylated Polyphenol

A subject of the invention is also the alkoxylated polyphenol as defined above having zo a viscosity ranging from 0.7 Pa·s to 40 Pa·s, preferably from 0.7 Pa·s to 30 Pa·s, measured at 40° C.

### Use

The invention also relates to the use of the grafted polyphenol as defined above as a reagent in various reactions. For example, it can be used as a reagent in alkoxylation processes.

As stated in the introduction, the grafted polyphenol according to the present invention is an extremely valuable reagent for “subsequent” alkoxylation reactions because of the more accessible hydroxyl functions.

The invention also relates to the use of the alkoxylated polyphenol as defined above as a reagent in various reactions. For example, it can be used as a reagent in alkoxylation processes.

The invention also relates to the use of the grafted polyphenol as defined above as a solvent for polyphenols, and also to the use of the alkoxylated polyphenol as defined above as a solvent for polyphenols.

According to yet another aspect, the invention relates to the use of the grafted polyphenol as defined above as a solvent in polyphenol alkoxylation processes, and also to the use of the alkoxylated polyphenol as defined above as a solvent in polyphenol alkoxylation processes.

Indeed, the grafted polyphenol and the alkoxylated polyphenol as defined above have the advantage of behaving like polyphenols while being (homogeneous, more or less viscous) liquids, said non-grafted and/or non-alkoxylated polyphenols generally, and usually, being solid at ambient temperature and pressure. Said grafted polyphenol and said alkoxylated polyphenol may thus constitute a solvent for said non-grafted and/or non-alkoxylated polyphenols that are solid at ambient temperature and pressure and also for alkoxylation reactions, and thereby allow these reactions on an industrial scale.

Finally, the invention relates to the use of the grafted polyphenol as defined above for producing polyurethanes, polyesters, nonionic or cationic surfactants, biobased precursors of carbon fiber. The invention also relates to the use of the alkoxylated polyphenol as defined above for producing polyurethanes, polyesters, nonionic or cationic surfactants, biobased precursors of carbon fiber. It is also conceivable to use the grafted polyphenol or the zo alkoxylated polyphenol as defined above for producing other compounds.

The present invention is further illustrated by the following nonlimiting examples.

### EXAMPLES

### Example 1

NMR analysis is performed on a Kraft lignin sample after derivatization with 2-chloro-4,4,5,5-tetramethyl-1,3,2-dioxaphospholane according to the method described by Argyropoulos et al., Res. Chem. Intermed., 21(3-5), 373-375, (1995). FIG. 1 is a ³¹P NMR spectrum of the initial Kraft lignin, derivatized by 2-chloro-4,4,5,5-tetramethyl-1,3,2-dioxaphospholane for the purpose of analysis. Peak A denotes aliphatic —OH functions, peak B denotes phenolic —OH functions and peak C denotes carboxylic acid —OH functions.

20 g of epoxy having a C₁₂ alkyl chain (Vikolox C₁₂) are charged to a stirred 100 cm³ reactor equipped with a condenser, a system for introducing a solid, a nitrogen inerting system, then 5 g of lignin (Indulin AT™) pre-impregnated with 0.5 g of a 50% aqueous solution of cesium hydroxide are added, and then dried. The ratio of (number of moles of Vikolox® C₁₂)/(number of —OH functions present per mole of lignins) is thus 13.35. The reaction medium is heated at 170° C. for 1 h 15 under atmospheric pressure. The medium obtained is homogeneous, liquid under hot conditions, and becomes viscous under cold conditions.

The NMR analysis shows the conversion of all the types of —OH functions mainly into secondary —OH functions resulting from the opening of the epoxide.

### Examples 2 to 8

Examples 2 to 8 were carried out with various contents of reagents, according to table 1 below:

TABLE 1

| Example | 2 | 3 | 4 | 5 | 6 | 7 | 8 |
|---|---|---|---|---|---|---|---|
| Indulin AT ™ Lignin (g) | 5 | 5 | 7.5 | 5 | 31.25 | 31.25 then | 40 |
| | | | | | | 15.6 | |
| Vikolox ® C₁₂ (g) | 40 | 40 | 20 | 20 | 125 | 125 | 80 |
| V/L Ratio ⁽¹⁾ | 26.71 | 26.71 | 8.90 | 13.35 | 13.35 | 13.35 | 6.68 |
| Nature of the catalyst | NaH | CsOH | CsOH | CsOH | CsOH | CsOH | CsOH |
| Weight of the catalyst (g) | 0.25 | 0.5 | 0.75 | 0.5 | 1.56 | 1.56 | 2 |
| Temperature (° C.) | 170 | 170 | 170 | 170 | 170 | 170 | 170 |

⁽¹⁾ Ratio of (Number of moles of Vikolox ® C₁₂)/(number of OH functions per mole of Indulin AT ™ lignin)

Examples 6, 7 and 8 are carried out in a 500 cm³ reactor.

### Examples 9 to 11

Examples 9 to 11 were carried out with an epoxy having a C₁₆ alkyl chain (Vikolox® C₁₆), according to table 2 below.

TABLE 2

| Example | 9 | 10 | 11 |
|---|---|---|---|
| Indulin AT ™ Lignin (g) | 5 | 5 | 7.5 |
| Vikolox ® C₁₆ (g) | 20 | 40 | 30 |
| V/L Ratio ⁽²⁾ | 10.24 | 20.48 | 10.24 |
| Nature of the catalyst | CsOH | CsOH | CsOH |
| Weight of the catalyst (g) | 0.5 | 0.5 | 0.5 |
| Temperature (° C.) | 170 | 170 | 170 |

⁽²⁾ Ratio of (Number of moles of Vikolox ® C₁₆)/(number of OH functions per mole of Indulin AT ™ lignin)

### Examples 12 to 14

Examples 12 to 14 were carried out with an epoxy having a C₁₈ alkyl chain (Vikolox® C₁₈), according to table 3 below.

TABLE 3

| Example | 12 | 13 | 14 |
|---|---|---|---|
| Indulin AT ™ Lignin (g) | 5 | 5 | 7.5 |
| Vikolox ® C₁₈ (g) | 20 | 30 | 40 |
| V/L Ratio ⁽³⁾ | 9.17 | 18.34 | 9.17 |
| Nature of the catalyst | CsOH | CsOH | CsOH |
| Weight of the catalyst (g) | 0.5 | 0.5 | 0.5 |
| Temperature (° C.) | 170 | 170 | 170 |

⁽³⁾ Ratio of (Number of moles of Vikolox ® C₁₈)/(number of OH functions per mole of Indulin AT ™ lignin)

### Examples 15 to 21

Examples 15 to 21 were carried out with an aromatic epoxy according to formula (IV) (Cardolite® NC-513), according to table 4 below.

TABLE 4

| Example | 15 | 16 | 17 | 18 | 19 | 20 | 21 |
|---|---|---|---|---|---|---|---|
| Indulin AT ™ Lignin (g) | 5 | 5 | 5 | 5 | 7.5 | 90 | 122.5 |
| Cardolite ® NC-513 (g) | 30 | 20 | 25 | 20 | 20 | 360 | 327 |
| Ratio C/L ⁽⁴⁾ | 10.32 | 6.88 | 8.60 | 6.88 | 4.59 | 6.88 | 5.00 |
| Nature of the catalyst | CsOH | CsOH | CsOH | KOH | CsOH | CsOH | CsOH |
| Weight of the catalyst (g) | 0.5 | 0.5 | 0.5 | 0.5 | 0.75 | 1.56 | 2 |
| Temperature (° C.) | 170 | 170 | 170 | 170 | 170 | 170 | 170 |

⁽⁴⁾ Ratio of (Number of moles of Cardolite ® NC-513)/(number of OH functions per mole of Indulin AT ™ lignin)

Examples 20 and 21 are carried out in a 300 cm³ reactor.

FIG. 2 is a ³¹P NMR spectrum of a grafted polyphenol obtained at the end of step (a), more specifically the grafted polyphenol as obtained according to example 20, derivatized by 2-chloro-4,4,5,5-tetramethyl-1,3,2-dioxaphospholane for the purpose of analysis. It is noted that peaks B and C have disappeared, indicating that all the phenolic —OH functions and the carboxylic acid functions have reacted with the compound of formula (I) (Cardolite® NC-513 epoxide) to give very predominantly a secondary alcohol in which the peak is in the zone of aliphatic —OH functions.

It is also noted that all the aliphatic —OH functions of different environment in the initial lignin (corresponding to peak A in FIG. 1) react with the compound of formula (I) to give a secondary —OH function of the same type as the other functions. This explains why the signals are no longer in the form of an unresolved peak as is the case for the initial lignin.

### Example 22: Example of Subsequent Alkoxylation (Step (B))

400 g of grafted lignin obtained according to example 20 and 4 g of finely ground CsOH are charged to a 6 I autoclave. The catalytic feedstock added is 1% relative to the grafted lignin introduced.

Three successive purges and the leak tests are carried out. The temperature of the reaction medium is gradually increased, under stirring, to 110° C. Nitrogen stripping is carried out at this temperature and under 200 mbar (0.02 MPa) for 30 minutes in order to dry the medium. A nitrogen pressure of 2.86 bar (0.286 MPa) is again applied and then a 40 g fraction of propylene oxide is introduced. The temperature is gradually raised to 140-150° C. At 145° C., it is observed that the reaction begins (pressure drop). All of the propylene oxide, i.e. 500 g, is introduced at a temperature of 150° C. and at a maximum pressure of 5.5 bar (0.55 MPa) at an average flow rate of 150 g/hour. The temperature is maintained at 150° C. until a pressure stationary phase is reached. At the end of the addition, the mixture is allowed to stand for 1 hour to consume all the propylene oxide, and then the residue is stripped with nitrogen for 1 hour at 100° C. 885 g of product are recovered in the form of a dark viscous liquid having a grafted lignin/PO (44/56) weight ratio. The product is homogeneous and does not contain unreacted lignin grain.

A ³¹P NMR analysis was carried out on the alkoxylated polyphenol obtained. FIG. 3 is a ³¹P NMR spectrum of the product obtained at the end of step (b), derivatized by 2-chloro-4,4,5,5-tetramethyl-1,3,2-dioxaphospholane for the purpose of analysis. It can be seen that only the characteristic peak of the aliphatic secondary —OH function is present.

1. A process for producing at least one grafted polyphenol, comprising at least the following step:
(a) reacting, in the presence of at least one catalyst, at least one polyphenol with at least one compound of formula (I) below: 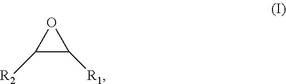
wherein:
R₁ is a linear or branched, saturated or unsaturated, C₃-C₃₀ hydrocarbon-based chain, optionally comprising one or more saturated or unsaturated rings, said chain being optionally interrupted by one or more heteroatoms chosen from the oxygen atom (O), the sulfur atom (S) and the nitrogen atom (N);
R₂ is chosen from a hydrogen atom and a linear or branched, saturated or unsaturated, C₁-C₆₀ hydrocarbon-based chain, optionally comprising one or more saturated or unsaturated rings, said chain being optionally interrupted by one or more heteroatoms chosen from the oxygen atom (O), the sulfur atom (S) and the nitrogen atom (N),
the number of moles of said compound of formula (I) being greater than or equal to the number of —OH functions present per mole of said polyphenol.

2. The process as claimed in claim 1, wherein said polyphenol is chosen from tannins, lignins and natural polyphenols other than tannins and lignins.

3. The process as claimed in claim 2, wherein said polyphenol is a lignin.

4. The process as claimed in claim 1, wherein the catalyst is chosen from alkali metal hydroxides, sodium or potassium alkoxides, and tertiary amines chosen from trialkylamines and tetramethylguanidine.

5. The process as claimed in claim 1, wherein R₁ is chosen from:
a group of formula (II) below: —(CH₂)ₙ—CH₃ (II), wherein n is an integer ranging from 2 to 29;
a group of formula (III) below: 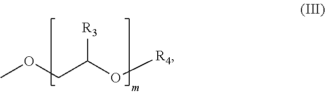
wherein:
R₃ is chosen from a hydrogen atom, a C₁-C₃ alkyl radical and a phenyl group;
m is an integer ranging from 1 to 15; and
R₄ denotes a hydrogen atom or a C₁-C₂₀ hydrocarbon-based chain;
a group of formula (IV) below: 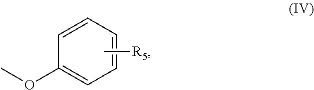
wherein R₅ denotes a linear or branched, saturated or unsaturated, C₅-C₂₀ hydrocarbon-based radical.

6. The process as claimed in claim 1, wherein R₂ is chosen from a hydrogen atom and a linear or branched, saturated or unsaturated, C₁-C₄₀ hydrocarbon-based chain.

7. The process as claimed in claim 1, wherein the number of moles of said compound of formula (I) is at least 1.1 times greater than or equal to the number of —OH functions present per mole of said polyphenol.

8. A process for producing at least one alkoxylated polyphenol comprising step (a), as defined in claim 1, followed by the following step:
(b) reacting the grafted polyphenol obtained at the end of step (a) with at least one alkoxylating agent of formula (V) below: 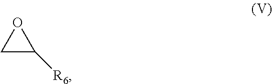
wherein R₆ denotes a hydrogen atom or a C₁-C₂ alkyl radical.

9. The process as claimed in claim 8, wherein step (b) is carried out in the presence of a catalyst which is identical to or different than the catalyst as defined in claim 1.

10. The process as claimed in claim 8, wherein the grafted polyphenol/alkoxylating agent weight ratio ranges from 0.05 to 2.

11. A grafted polyphenol that can be obtained by the process as defined in claim 1.

12. An alkoxylated polyphenol that can be obtained by the process as defined in claim 8.

13. The use of the grafted polyphenol as defined in claim 11, as a reagent in alkoxylation processes.

14. The use of the grafted polyphenol as defined in claim 11, as a solvent for polyphenols.

15. The use of the grafted polyphenol as defined in claim 11, as a solvent in polyphenol alkoxylation processes.

16. The use of the grafted polyphenol as defined in claim 11, for producing polyurethanes, polyesters, nonionic or cationic surfactants, biobased precursors of carbon fiber.
